(19) United States
(12) Patent Application Publication
(10) Pub. No.: US 2025/0001745 A1
(43) Pub. Date: Jan. 2, 2025

(54) Carbon Susceptors for Thermoplastic Composite Induction Welding

(71) Applicants: Jeffrey Wiggins, Petal, MS (US); Olivia McNair, Petal, MS (US); Christopher CROSHAW, San Diego, CA (US); Zhiyong LIANG, Tallahassee, FL (US)

(72) Inventors: Jeffrey Wiggins, Petal, MS (US); Olivia McNair, Petal, MS (US); Christopher CROSHAW, San Diego, CA (US); Zhiyong LIANG, Tallahassee, FL (US)

(73) Assignees: The University of Southern Mississippi, Hattiesburg, MS (US); Florida State Research Foundation, Inc., Tallahassee, FL (US)

(21) Appl. No.: 18/757,443

(22) Filed: Jun. 27, 2024

Related U.S. Application Data
(60) Provisional application No. 63/511,074, filed on Jun. 29, 2023.

(51) Int. Cl. B32B 27/12; B29C 43/18; B29K 71/00; B29K 707/04; B32B 5/02; B32B 5/26; B32B 27/28

(52) U.S. Cl. CPC B32B 27/12; B32B 5/02; B32B 5/26; B32B 27/285; B29C 43/18; B29K 2071/00; B29K 2707/04; B32B 2250/05; B32B 2262/106; B32B 2307/302; B32B 2307/514; B32B 2307/7376

(57) ABSTRACT

A thermoplastic composite suitable for induction welding including a polymer laminate including two or more plies, wherein the polymer is selected from polyaryletherketone (PAEK) polymers such as polyetherketone (PEK), polyether ether ketone (PEEK), polyetherketoneketone (PEKK), polyetheretherketoneketone (PEEKK), and polyetherketoneetherketoneketone (PEKEKK), or preferably, the polymer laminate comprises polyetherketoneketone (PEKK), and one or more layers of a continuous carbon nanomaterial based susceptor between each pair of the plies. Methods for making the thermoplastic composite are also described.

### CROSS REFERENCE TO RELATED APPLICATIONS

This application claims the benefit of U.S. Provisional Application No. 63/511,074, filed on Jun. 29, 2023, the entire disclosure of which is hereby incorporated by reference as if set forth fully herein.

### STATEMENT OF GOVERNMENT INTEREST

This invention was made with government support under grant no. 80NSSC20M0165 from the National Aeronautics and Space Administration. The government has certain rights in the invention.

### BACKGROUND

Induction welding has the potential to allow for lightweight, fastener-free assembly of thermoplastic composite structures. However, current induction welding rates are between 1 mm/s-3 mm/s, relegating induction welding to low volume, niche applications. Induction welding is fundamentally limited by the heating rate of the thermoplastic composite laminate under the induction coil. Induction welding of thermoplastic composites is interesting for applications in the aerospace fabrication and manufacturing communities for low-cost rapid assembly of secondary and primary composite structures.

Previous work has demonstrated that carbon nanomaterials can accelerate polyetherketoneketone (PEKK) crystallization. This addressed one of the considerations for high-rate thermoplastic composites manufacturing: faster crystallization. Carbon nanomaterials also have the potential to improve heating rates for processes such as radio frequency (RF) and induction heating, i.e. heating in the presence of an electric field. Recent advances in RF heating demonstrated the ability of carbon nanomaterials to heat in the presence of electric fields. Green et al. achieved a 16° C./s heating rate at 5 MHz at a power of 315 Watts in a polylactic acid/carbon nanotube nanocomposite.⁸ RF heating, unlike induction welding, uses high enough frequencies, typically between 1-200 MHz to induce dielectric heating sufficient to melt samples.

US 2021/0237369 relates to an energy converting film comprising a thermoplastic polymer or a thermoset polymer, a susceptor component, and a carbon component, such as carbon nanotubes.

US 2020/0214090 relates to a composite fibrous susceptor for use in induction welding, including a magnetically susceptible continuous fiber and a thermoplastic polymer such as polyetheretherketone.

### SUMMARY OF THE INVENTION

Herein is described a thermoplastic composite suitable for induction welding including a polymer laminate including two or more plies, wherein the polymer is selected from polyaryletherketone (PAEK) polymers such as polyetherketone (PEK), polyether ether ketone (PEEK), polyetherketoneketone (PEKK), polyetheretherketoneketone (PEEKK), and polyetherketoneetherketoneketone (PEKEKK), or preferably, the polymer is polyetherketoneketone (PEKK), and one or more layers of a continuous carbon nanomaterial based susceptor located between each pair of the plies. Continuous carbon nanotube sheets are located between each ply in the PEKK laminate to improve heat generation. Heating rates increased by up to 34% and the maximum temperature reached during induction heating increased by up to 37° C. compared to neat PEKK laminates without the susceptor layers. Additionally, cycle times for induction welding were calculated to be reduced by 30%.

In one embodiment, the polymer is polyetherketoneketone. The carbon nanomaterial may be a continuous carbon nanotube sheet. Each of the one or more layers of the carbon nanomaterial may have a thickness of from about 10 μm to about 50 μm, or from about 15 μm to about 30 μm, or about 15 μm to about 25 μm, or about 20 μm. The carbon nanomaterial may be present in an amount of from about 0.5 wt. % to about 20 wt. %, or from about 1 wt. % to about 15 wt. %, or from about 1.5 wt. % to about 10 wt. %, based on a total weight of the composite.

The composite may have an induction heating rate of greater than 14° C./s to less than 20° C./s at a power of 30 Watts, or greater than 15° C./s at a power of 30 Watts, or about 17° C./s at a power of 30 Watts.

The composite may have an induction heating rate of greater than 1° C./s to less than 6° C./s at a power of 2 Watts, or greater than 1.25° C./s at a power of 2 Watts, or about 1.5° C./s at a power of 2 Watts. Alternatively, the composite may have an induction heating rate of greater than 3° C./s to less than 9.25° C./s at 5 Watts, or greater than 5.5° C./s at 5 Watts, or about 6° C./s at 5 Watts. The composite may have an induction heating rate of greater than 6° C./s to less than 14° C./s at 10 Watts, or greater than 8.5° C./s at 10 Watts, or about 9.25° C./s at 10 Watts. The composite may have an induction heating rate of greater than 9.25° C./s to less than 17° C./s at 20 Watts, or greater than 13° C./s at 20 Watts, or about 14° C./s at 20 Watts.

The polymer laminate may include a polyetherketoneketone having a number average molecular weight of from about 10,000 g/mol to about 100,000 g/mol, or from about 20,000 g/mol to about 50,000 g/mol, as measured by gel permeation chromatography, or the polymer laminate may include a polyetherketoneketone having a weight average molecular weight of from about 10,000 g/mol to about 100,000 g/mol, or from about 20 g/mol to about 80,000 g/mol, as measured by gel permeation chromatography.

Each ply in the composite preferably includes oriented carbon fibers. The carbon fiber orientation may be 0/90 and may be repeated eight times for a total of 16 plies and these 16 plies may be mirrored with another 16 plies for a total of 32 plies. The composite may contain at least 16 plies. The composite may contain 32 plies.

The thermoplastic composite may include two or more layers of the carbon nanomaterial based susceptor between each pair of plies, or three or more layers of the carbon nanomaterial based susceptor between each pair of plies.

The thermoplastic composite may be configured to have a cycle time for induction welding of less than 70 seconds, or less than 60 seconds, or from about 50 seconds to about 55 seconds, wherein the cycle time is defined as the time between the thermoplastic composite exceeding its T_{g} and the thermoplastic composite cooling to below its T_{g}.

Also described is a method for preparing the thermoplastic composite by heating and applying pressure via compression molding to the carbon nanomaterial based susceptor onto a surface of the polymer laminate to form the thermoplastic composite.

In the method, the compression molding may be carried out at a temperature of 200° C. to about 500° C., or from about 300° C. to about 400° C., or about 380° C. The compression molding may be carried out at a pressure of from about 100 psi to about 200 psi, or from about 110 psi to about 150 psi, or from about 120 psi.

The method may further include a step of cooling the heated thermoplastic composite at a rate of about 1° C./min.

Additional details and advantages of the disclosure will be set forth in part in the description which follows, and/or may be learned by practice of the disclosure. The details and advantages of the disclosure may be realized and attained by means of the elements and combinations particularly pointed out in the appended claims. It is to be understood that both the foregoing general description and the following detailed description are exemplary and explanatory only and are not restrictive of the disclosure, as claimed.

### BRIEF DESCRIPTION OF THE DRAWINGS

FIG. 1 shows a PEKK composite laminate under an induction coil with thermocouples attached.

FIG. 2 shows induction heating profiles of PEKK laminates with PEKK nanocomposite films.

FIG. 3 shows interlaminar regions of a PEKK composite with (right) and without (middle) a continuous carbon nanotube (CCN) embedded susceptor.

FIG. 4 shows PEKK composite panel design with CCN susceptor locations (top left), PEKK composite preform (top middle), preform with CCN susceptors (bottom left), consolidated induction heating samples (bottom middle), and the induction welding setup.

FIG. 5 shows heating profiles during induction heating experiments.

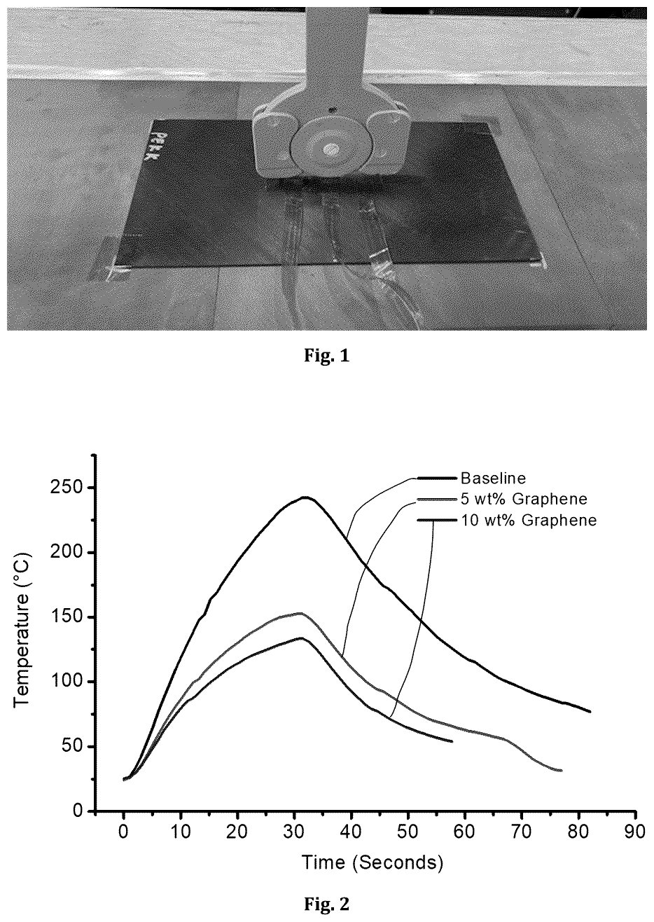

### DESCRIPTION

This present invention significantly improves the heating rate and maximum temperature, for composite fabrication by increasing heat generated during the induction welding process for faster fabrication. This will enable widespread use and adoption of induction welding technology for composite structure fabrication. The key problem with prior art induction welding is slow welding rates due to insufficient induction heating rates.

This invention exemplified a variety of continuous carbon nanotubes to improve induction heating of polymer composites in the presence of alternating electric fields in both the kHz and MHz frequency range.

The thermoplastic composite of the present invention may include a polymer laminate comprising one or more plies. The one or more thin plies may have a thickness of from about 0.05 mm to about 0.5 mm, or about 0.18 mm.

The polymer laminate may comprise a polymer in the family of polyaryletherketone (PAEK) polymers. For example, the polymer laminate may be selected from the group consisting of polyetherketone (PEK), polyether ether ketone (PEEK), polyetherketoneketone (PEKK), polyetheretherketoneketone (PEEKK), and polyetherketoneetherketoneketone (PEKEKK), or preferably, the polymer laminate comprises polyetherketoneketone (PEKK).

The polyetherketoneketone may have a number average molecular weight of from about 10,000 g/mol to about 100,000 g/mol, or from about 20,000 g/mol to about 50,000 g/mol, as measured by gel permeation chromatography.

PEKK is advantageous as it includes a second ketone group, which increases polarity and backbone rigidity, which results in an increase in glass transition and melting temperature when compared to other PAEK polymers, such as PEEK. Furthermore, PEKK displays both amorphous and semi-crystalline behavior.

Each ply in the composite preferably includes oriented carbon fibers. The carbon fiber orientation may be 0/90 and may be repeated eight times for a total of 16 plies and these 16 plies may be mirrored with another 16 plies for a total of 32 plies. The composite may contain at least 16 plies. The composite may contain 32 plies.

The polymer laminate may comprise one or more layers of a continuous carbon nanomaterial based susceptor between each pair of plies. A susceptor is a material that absorbs electromagnetic energy and converts it to heat. For example, electromagnetic energy may be provided by radiofrequency or microwave radiation. Preferably, the carbon nanomaterial comprises a continuous carbon nanotube sheet. The continuous carbon nanotube sheet of the present invention may be prepared using the Huntsman's Floating Catalyst Chemical Vapor Deposition process (FC-CVD). This process is a highly efficient, near-zero waste process employing methane gas, a by-product of oil and gas production, to create two useful products MIRALON® and hydrogen.

The continuous carbon nanotube sheet may have a thickness of from about 1 μm to about 50 μm, or from about 3 μm to about 30 μm, or about 4 μm to about 25 μm, or up to about 20 μm. The continuous carbon nanotube sheet may have a specific strength of from about

$$50 \frac{MPa}{\frac{g}{{cm}^{3}}} - 200 \frac{MPa}{\frac{g}{{cm}^{3}}} .$$

The continuous carbon nanotube sheet may have a specific electrical conductivity at 20° C. of from about

$$300 \frac{S * {cm}^{2}}{g}$$

to about

$$800 \frac{S * {cm}^{2}}{g} ,$$

or from about

$$400 \frac{S * {cm}^{2}}{g}$$

to about

$$700 \frac{S * {cm}^{2}}{g} ,$$

or about

$$600 \frac{S * {cm}^{2}}{g} .$$

The continuous carbon nanotube sheet may be present in an amount of from about 0.5 wt. % to about 20 wt. %, or from about 1 wt. % to about 15 wt. %, or from about 1.5 wt. % to about 10 wt. %, based on the total weight of the composite material. One or more sheets of the continuous carbon nanotube sheet may be located between each pair of plies. Preferably, 2 or 3 sheets of the continuous carbon nanotube sheet are located between each pair of plies.

### Examples

The following examples are illustrative, but not limiting, of the methods and compositions of the present disclosure. Other suitable modifications and adaptations of the variety of conditions and parameters normally encountered in the field, and which are obvious to those skilled in the art, are within the spirit and scope of the disclosure. All patents and publications cited herein are fully incorporated by reference herein in their entirety.

Induction Heating of PEKK Composites with Embedded Carbon Susceptors

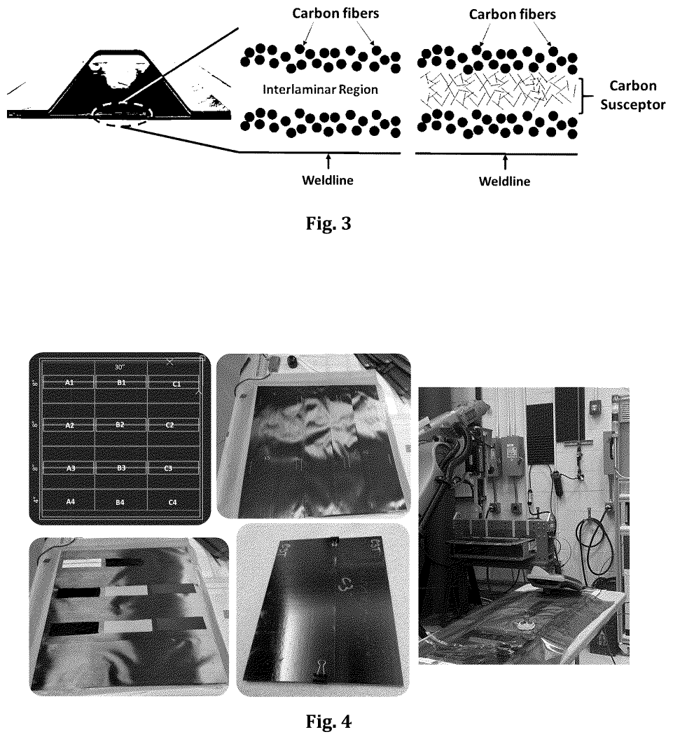

PEKK laminates with a continuous carbon nanotube (CCN) sheet embedded between plies were fabricated to evaluate their heating performance during induction welding. A ply sequence of [0/90]₈ₛ was used due to case of processing and the potential for high heating rates due to cross ply interactions. The rationale for using CCN sheets for induction heating comes from the equation governing induction heating:

$${\dot{Q}}^{′′′} = σ \vec{E} \cdot \vec{E}$$

where \dot{Q}′″ is the volumetric heat generation, σ is electrical conductivity, and \vec{E} is the electric field vector. Therefore, by increasing the electrical conductivity within the laminate, the volumetric heating rate should also increase. Additionally, for the Eddy currents to form, they must exist in a closed loop. Therefore, by adding electrically conductive CCN sheets between layers in the interlaminar regions, more pathways are created for Eddy currents to be formed and Eddy currents can be bridged between layers. FIG. 3 depicts the difference for laminates with embedded CCN susceptors.

PEKK composite laminates with dimensions of 30″×30″ were manufactured using PEKK/AS4D UD tape. The PEKK composite laminates were designed to yield 21, 10″×4″ induction heating samples with carbon susceptors embedded only in the 1″ interface used for welding (FIG. 4). One to three layers of CCN sheets were added between plies, and a soldering iron was used to adhere the CCN to the plies prior to consolidation. One to three CCN sheets were tacked between every ply in the laminate, thus the naming convention for PEKK laminates with embedded CCN susceptors is CCN-1, CCN-2, and CCN-3 depending on how many sheets were embedded between every ply. Once the lay-up process was complete, the PEKK composite preform was compression molded at 380° C. for 20 minutes at 120 psi to consolidate it. The laminate was cooled at approximately 1° C./min under continuous pressure. Once the PEKK laminate with embedded CCN susceptors was consolidated, 10″×4″ induction welding specimens were cut out using a diamond saw.

Induction heating experiments were performed using a 10 kW power supply. A current of 625 amperes was used to generate an electric field of 295 kHz. The induction coil was attached to a robotic arm and swept over the PEKK composite laminates at a rate of 5.5 mm/s. The distance between the induction coil and the laminates was 10 mm. The vacuum bag set up during induction heating trials is shown in FIG. 4. Two 10″×4″ laminates with identical embedded susceptor technology (either both had no susceptors or the same quantity of CCN sheets between each layer) were placed such that a 1″ overlap was present between laminates. Thermocouples were placed between the two laminates to measure heating rate and temperature.

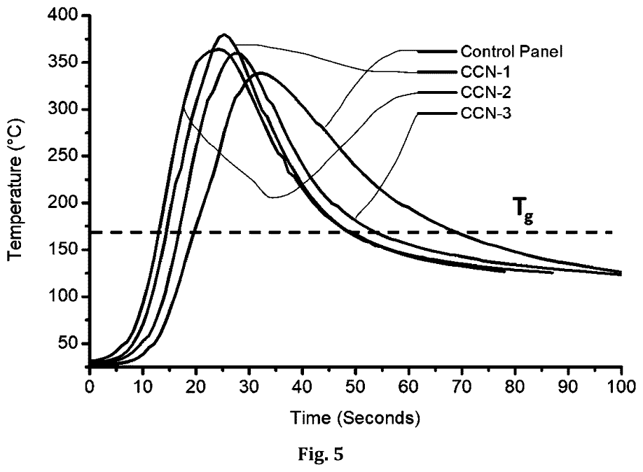

Heating profiles for the induction heating experiments are shown in FIG. 5. PEKK laminates with embedded CCN susceptors (Miralon™) heated faster and to higher maximum temperatures than the control panel with no susceptors. CCN-2 had the fastest heating rate of all the CCN samples, of 29.8° C./s. CCN-1 and CCN-3 had heating rates of 28.6° C./s and 29.3° C./s, respectively. It is expected that if the experiments had been run in triplicate, there would have been no significant difference between the three CCN samples. Additionally, CCN-1 had a maximum heating rate of 28.6° C./s and a highest maximum temperature of 380° C. whereas the control panel had a maximum heating rate and temperature of 22.4° C./s and 343° C., respectively. The CCN samples achieved an 11% improvement in maximum temperature and a 34% increase in heating rate both of which are significant improvements. The only difference between the panels was the inclusion of CCN sheets between plies. This supports the conclusion that the improvement in volumetric heat generation is due to the increase in through thickness electrical conductivity. These results also indicate that the quantity of CCN between layers did not significantly influence the induction heating behavior.

TABLE 1

| | Peak Heating Rate | | |
|---|---|---|---|
| | (° C./s) | Peak Temperature (° C.) | Cycle Time (s) |
| Control | 22.4 | 343 | 71 |
| CCN-1 | 28.6 | 380 | 50 |
| CCN-2 | 29.8 | 364 | 50 |
| CCN-3 | 29.3 | 360 | 55 |

### Table 1 Shows Induction Heating Data for PEKK Composites with and without Embedded CCN Susceptors

Cycle time is the time it takes for the induction welding process to go from start to finish. The cycle time was quantified by measuring from the time at which heating begas (t=0) to the time required to cool the composite below the glass transition temperature (T_{g}). T_{g} is considered to be the end point of the induction welding cycle because once the temperature of the PEKK is below its T_{g}, crystallization can no longer occur, and the mechanical properties have evolved to the point that the specimen would hold its shape upon removal from fixtures or tools.

The cycle time was found to be between 50-55 seconds for CCN samples, whereas the control panel had a cycle time of 71 seconds (Table 6.1). Thus, the CCN samples exhibited reductions in cycle time of up to 30%. The improved heating rate contributed significantly to the reduced cycle time. Further, FIG. 5 shows a faster cooling rate for the CCN samples. No external cooling was used in this process and thus the cooling rate can be attributed to the thermal conductivity of the samples. Therefore, it appears that the CCN samples had significantly higher thermal conductivities than the control panel, allowing for accelerated heat dissipation after the induction heating process was completed.

CCN-1 reached a maximum temperature 37° C. higher than the control panel. If the control panel reached 380° C. it would require longer to both heat up and cool down. Therefore, it is likely that the improvement in cycle time was actually underestimated by these experiments. This is both an unexpected and important result since faster cooling rates are highly desirable for high-rate fabrication of thermoplastic composites.

### CONCLUSIONS

CCN susceptors were then embedded within a PEKK composite laminate and their induction heating performance was evaluated. The inclusion of CCN within the laminate was found to significantly increase heating rates, maximize heating temperatures, increase cooling, and reduce cycle times for induction welding.

Other embodiments of the present disclosure will be apparent to those skilled in the art from consideration of the specification and practice of the embodiments disclosed herein. As used throughout the specification and claims, “a” and/or “an” may refer to one or more than one. Unless otherwise indicated, all numbers expressing quantities of ingredients, properties such as molecular weight, percent, ratio, reaction conditions, and so forth used in the specification and claims are to be understood as being modified in all instances by the term “about,” whether or not the term “about” is present. Accordingly, unless indicated to the contrary, the numerical parameters set forth in the specification and claims are approximations that may vary depending upon the desired properties sought to be obtained by the present disclosure. At the very least, and not as an attempt to limit the application of the doctrine of equivalents to the scope of the claims, each numerical parameter should at least be construed in light of the number of reported significant digits and by applying ordinary rounding techniques. Notwithstanding that the numerical ranges and parameters setting forth the broad scope of the disclosure are approximations, the numerical values set forth in the specific examples are reported as precisely as possible. Any numerical value, however, inherently contains certain errors necessarily resulting from the standard deviation found in their respective testing measurements. It is intended that the specification and examples be considered as exemplary only, with a true scope and spirit of the disclosure being indicated by the following claims.

The foregoing embodiments are susceptible to considerable variation in practice. Accordingly, the embodiments are not intended to be limited to the specific exemplifications set forth hereinabove. Rather, the foregoing embodiments are within the spirit and scope of the appended claims, including the equivalents thereof available as a matter of law.

The patentees do not intend to dedicate any disclosed embodiments to the public, and to the extent any disclosed modifications or alterations may not literally fall within the scope of the claims, they are considered to be part hereof under the doctrine of equivalents.

It is to be understood that each component, compound, substituent or parameter disclosed herein is to be interpreted as being disclosed for use alone or in combination with one or more of each and every other component, compound, substituent or parameter disclosed herein.

It is also to be understood that each amount/value or range of amounts/values for each component, compound, substituent or parameter disclosed herein is to be interpreted as also being disclosed in combination with each amount/value or range of amounts/values disclosed for any other component(s), compounds(s), substituent(s) or parameter(s) disclosed herein and that any combination of amounts/values or ranges of amounts/values for two or more component(s), compounds(s), substituent(s) or parameters disclosed herein are thus also disclosed in combination with each other for the purposes of this description.

It is further understood that each range disclosed herein is to be interpreted as a disclosure of each specific value within the disclosed range that has the same number of significant digits. Thus, a range of from 1-4 is to be interpreted as an express disclosure of the values 1, 2, 3 and 4.

It is further understood that each lower limit of each range disclosed herein is to be interpreted as disclosed in combination with each upper limit of each range and each specific value within each range disclosed herein for the same component, compounds, substituent or parameter. Thus, this disclosure to be interpreted as a disclosure of all ranges derived by combining each lower limit of each range with each upper limit of each range or with each specific value within each range, or by combining each upper limit of each range with each specific value within each range.

Furthermore, specific amounts/values of a component, compound, substituent or parameter disclosed in the description or an example is to be interpreted as a disclosure of either a lower or an upper limit of a range and thus can be combined with any other lower or upper limit of a range or specific amount/value for the same component, compound, substituent or parameter disclosed elsewhere in the application to form a range for that component, compound, substituent or parameter.

What is claimed is:

1. A thermoplastic composite suitable for induction welding comprising:
a polymer laminate including two or more plies each including a polyaryletherketone polymer, and
one or more layers of a continuous carbon nanomaterial based susceptor located between each pair of the plies.

2. The composite of claim 1, wherein the polymer is polyetherketoneketone.

3. The composite of claim 1, wherein the carbon nanomaterial is a continuous carbon nanotube sheet.

4. The composite of claim 1, wherein each of the one or more layers of the carbon nanomaterial has a thickness of from about 10 μm to about 50 μm.

5. The composite of claim 1, wherein the carbon nanomaterial is present in an amount of from about 0.5 wt. % to about 20 wt. %, based on a total weight of the composite.

6. The composite of claim 1, wherein the polyaryletherketone (PAEK) is selected from the group consisting of polyetherketone (PEK), polyether ether ketone (PEEK), polyetherketoneketone (PEKK), polyetheretherketoneketone (PEEKK), and polyetherketoneetherketoneketone (PEKEKK).

7. The composite of claim 1, wherein the composite has an induction heating rate of greater than 14° C./s to less than 20° C./s at a power of 30 Watts, or an induction heating rate of greater than 1° C./s to less than 6° C./s at a power of 2 Watts, or an induction heating rate of greater than 3° C./s to less than 9.25° C./s at 5 Watts, or an induction heating rate of greater than 6° C./s to less than 14° C./s at 10 Watts or an induction heating rate of greater than 9.25° C./s to less than 17° C./s at 20 Watts.

8. The composite of claim 1, wherein the polymer laminate comprises a polyetherketoneketone having a number average molecular weight of from about 10,000 g/mol to about 100,000 g/mol, as measured by gel permeation chromatography.

9. The composite of claim 1, wherein the thermoplastic composite comprises two layers of the carbon nanomaterial based susceptor between each pair of plies.

10. The composite of claim 1, wherein the thermoplastic composite comprises three layers of the carbon nanomaterial based susceptor between each pair of plies.

11. The composite of claim 1, wherein the thermoplastic composite is configured to have a cycle time for induction welding of less than 70 seconds, wherein the cycle time is defined as the time between the thermoplastic composite exceeding its T_{g} and the thermoplastic composite cooling to below its T_{g}.

12. The composite of claim 1 wherein each ply includes oriented carbon fibers.

13. The composite of claim 12, wherein the carbon fiber orientation is 0/90 and is repeated eight times for a total of 16 plies and the 16 plies are mirrored with another 16 plies for a total of 32 plies.

14. The composite of claim 12, comprising at least 16 plies.

15. The composite of claim 12, comprising 32 plies.

16. A method for preparing the thermoplastic composite of claim 1, comprising a step of:
heating and applying pressure via compression molding to the carbon nanomaterial based susceptor onto a surface of the polymer laminate to form the thermoplastic composite.

17. The method of claim 14, wherein the compression molding is carried out at a temperature of 200° C. to about 500° C.

18. The method of claim 15, wherein the compression molding is carried out at a pressure of from about 100 psi to about 200 psi.

19. The method of claim 15, further comprising a step of cooling the heated thermoplastic composite at a rate of about 1° C./min.

20. The method of claim 15, wherein the compression molding is carried out at a pressure of from about 110 psi to about 150 psi.
